(19) United States
(12) Patent Application Publication
(10) Pub. No.: US 2009/0155509 A1
(43) Pub. Date: Jun. 18, 2009

(54) Holographic Flexible Tube Laminate For Packaging and Method of Making the Same

(76) Inventors: Suresh Vedprakash Gupta, Maharashtra (IN); Jaikumar Ramnath Raikar, Maharashtra (IN); Mahesh Raghunath Kode, Maharashtra (IN)

Correspondence Address: MORRIS MANNING MARTIN LLP, 3343 PEACHTREE ROAD, NE, 1600 ATLANTA FINANCIAL CENTER, ATLANTA, GA, 30326, US

(21) Appl. No.: 12/087,372

(22) PCT Filed: Dec. 4, 2006
(86) PCT No.: PCT/IN2006/000485

§ 371 Date: Jul. 2, 2008

(30) Foreign Application Priority Data
Dec. 2, 2005 (IN) 1495/MUM/2005

(51) Int. Cl. B32B 1/08; B32B 3/30; B32B 15/04; B65D 65/40; B65D 35/02

(52) U.S. Cl. 428/35.7; 156/160

(57) ABSTRACT

A holographic flexible tube laminate for packaging and a method of making the same. A flexible laminate substrate applied with an adhesive layer has a metalised holographic embossed pattern transferred onto the adhesive layer. The holographic side of the laminate substrate is further optionally applied with corona treatment, printed and applied with a protective transparent material coating. The edges of the laminate substrate without the adhesive layer are lap joined by heat sealing to form the tube laminate.

### FIELD OF INVENTION

This invention relates to holographic flexible tube laminate for packaging and method of making the same.

Holographic embossed pattern is incorporated in packagings to improve the aesthetic and graphic appearance of the products contained in the packagings and/or to indicate the genuineness of the products and prevent tampering with or counterfeiting of the products. The term ‘pattern’ as used in the specification includes one or more images, pictures, designs, monograms, logos, graphics, trademarks or names or devices or combinations thereof.

### BACKGROUND OF INVENTION

Plastic films used for packaging are provided with holographic embossed pattern by coating the films with a thermoplastic lacquer followed by holographically embossing the desired pattern on the lacquer coating under pressure and temperature conditions which will depend upon the nature of the lacquer used. The holographic embossed pattern is optionally vacuum metalised and subjected to corona treatment prior to printing or lamination. The printed side of the films is optionally provided with a protective transparent material coating or the film is laminated to another film. The holographically embossed films as such can be used as packaging materials or can be formed into containers like bags, pouches, sachets or the like. In order to heat seal the joint of the containers formed, the laminate of the holographically embossed films are generally laminated with a heat sealable film.

Cellulose paper comprising holographic embossed pattern transferred onto it is used as packing or wrapping material. It does not have the mechanical strength to be formed into and used as flexible tubes for packaging semisolid or viscous materials like toothpaste, ointments, lotions or the like. Flexible tube laminates provided with holographic embossed pattern for packaging semi-solid or viscous materials are made by sandwiching and laminating holographically embossed films made as described above between the layers or laminations of the laminate substrate followed by forming the laminate substrate into tube laminate and beat sealing the edges thereof. During long periods of storage and repeated and rigorous handling of the flexible tube laminates by way of pressing and squeezing, the bond between the plastic film with the holographic embossed pattern and the layers or laminations of the laminate substrate weakens and causes the film to open up or delaminate thereby reducing the integrity and cohesion of the tube and also spoiling the appearance of the tube. Even if the film does not open up completely there will still be signs of delamination spoiling the integrity and cohesion and appearance of the tube. Besides, the clarity and visibility of the holographic embossed pattern is reduced because of the pattern being sandwiched between the laminations of the laminate substrate. Non-laminate type flexible tubes for packaging semisolid or viscuous materials are generally made of aluminium which is not amenable to direct holographic embossing. Lamination of holographically embossed films onto the aluminium tube substrates will not ensure a lasting bond between the substrate and film. As a result, the film will delaminate or open up thereby spoiling the integrity and cohesion and also appearance of the tube.

### OBJECTS OF INVENTION

An object of the invention is to provide a holographic flexible tube laminate for packaging, which tube laminate is simple in construction and maintains its integrity and cohesion and also aesthetic and graphic appearance over a long time.

Another object of the invention is to provide a holographic flexible tube laminate for packaging, which tube laminate imparts increased clarity and visibility to the holographic embossed pattern.

Another object of the invention is to provide a method of making a holographic flexible tube laminate for packaging, which method is simple and easy to carry out and produces tube laminates having the above advantages.

### DETAILED DESCRIPTION OF THE INVENTION

According to the invention there is provided a holographic flexible tube laminate for packaging, the tube laminate comprising a flexible laminate substrate applied with an adhesive layer having a metalised holographic embossed pattern transferred onto the adhesive layer, the holographic side of the laminate substrate being further optionally applied with corona treatment, printed and applied with a protective transparent material coating, the edges of the laminate substrate being without the adhesive layer and being lap joined by heat sealing to form the tube laminate.

According to the invention there is also provided a method of making a holographic flexible tube laminate for packaging, the method comprising the steps of:
(i) transferring a metalised holographic embossed pattern onto an adhesive layer applied on a flexible laminate substrate leaving out the edges of the laminate substrate;
(ii) optionally giving corona treatment to the holographic side of the laminate substrate;
(iii) printing the holographic side of the laminate substrate;
(iv) applying a protective transparent material coating on the printed side of the laminate substrate; and
(v) forming the laminate substrate into a tube by lap joining the edges of the laminate substrate by heat sealing.

Preferable, the flexible laminate substrate has a thickness of 150-400 microns and it comprises plastic films laminated together or plastic films and aluminium foils laminated together. The adhesive used on the laminate substrate has to have excellent adhesion to the laminate substrate. Preferably the adhesive layer has a thickness of 1.5 to 5 GSM and it comprises reactive polyurethane based adhesive. Preferably the protective transparent material coating has a thickness of 0.5 to 5 GSM and it comprises UV curing varnish. The plastic film used for forming the laminate substrate or the holographic embossed pattern is selected from Polyester films (PET), Baxially Oriented Polypropylene films (BOPP), Cast Polypropylene films (CPP), Polyethylene Poly Vinyl Chloride (PVC) films or Oriented Polyamide films. Instead of aluminium foils, other metal foils can be used in the laminate substrate.

Preferably, the transfer of the metalised holographic embossed pattern is carried out by laminating a plastic film having the metalised holographic embossed pattern onto the flexible laminate substrate followed by delaminating the film.

According to the invention the holographic embossed and metalised pattern is transferred onto the adhesive layer well adhered on the flexible laminate substrate and the edges of the laminate without the adhesive are heat sealed to form the tube. Further the holographic embossed pattern is protected against damage by the protective transparent coating. The holographic embossed image remains transferred on the surface of adhesive layer well adhered onto the surface of the tube laminate. Therefore, the integrity and adhesion as well as aesthetic appeal and appearance of the tube is maintained even after long storage and repeated and rigorous use over a period of time. The clarity and visibility of the holographic embossed pattern is also significantly improved because of its being at the surface of the tube laminate. The tube laminate is flexible and has adequate mechanical strength for use as packaging semisolid or viscous materials. The tube laminate configuration and construction is thus very much simplified. The method of the invention is also simple and easy to carry out.

It is to be clearly understood that any flexible laminate structure can have the holographic embossed pattern transferred onto the adhesive layer applied thereon according to the method of the invention. The structure so formed need not be tube laminate and can be of other shapes or can be flat. The transfer of the holographic embossed pattern onto the adhesive layer can also be carried by any other manner. Such variations in the construction and configuration of the invention are to be construed and understood to be within the scope of the invention.

The following experimental example is illustrative of the invention but not limitative of the scope thereof:

### EXAMPLE 1

Polyester film of 12 microns thickness was coated with a thermoplastic lacquer comprising cellulose acetate propionate and polyvinyl acetate under 1 bar pressure and at 115° C. temperature to form a coating of 1 GSM thickness. The film was holographically embossed and vacuum metalised and the holographic embossed, and metalised pattern was transferred onto a reactive polyurethane based adhesive layer of 2.5 GSM thickness applied on a flexible laminate substrate comprising polyethylene films and aluminium foils and having a thickness of 250 microns by laminating the holographic embossed film onto the flexible laminate substrate. The film was delaminated and the adhesive side of the laminate substrate having the holographic embossed pattern was subjected to corona treatment followed by printing and application of a coating of UV curing varnish to a thickness of 1 GSM. The laminate substrate was slit into 9 number of coils each having the holographically embossed pattern. The coils were formed into tubes and the edges of the laminate coils protruding out of the adhesive layer were lap joined by heat sealing. The tube laminates did not delaminate and open up even after long storage and repeated pressing and twisting. The integrity and adhesion as well as aesthetic appearance and appeal of the tube laminates were maintained. The clarity and visibility of the holographic embossed pattern was also excellent.

1. A holographic flexible tube laminate for packaging, the tube laminate comprising a flexible laminate substrate applied with an adhesive layer on one outer surface thereof leaving out the edges thereof and having a metalised holographic embossed pattern transferred onto the adhesive layer, the holographic side of the laminate substrate being further applied with corona treatment optionally, printed and applied with a protective transparent material coating comprising ultraviolet curing varnish, the laminate substrate being folded into a tube with the protective material coating side of the laminate substrate forming the outside of the tube and the edges of the laminate substrate without the adhesive layer being lap joined by heat sealing to form the tube laminate.

2. The tube laminate as claimed in claim 1, wherein the adhesive layer has a thickness of 1.5 to 5 GSM and the adhesive is reactive polyurethane based adhesive.

3. The tube laminate as claimed in claim 1, wherein the flexible laminate substrate has a thickness of 150 to 400 microns and comprises plastic films laminated together.

4. The tube laminate as claimed in claim 1, wherein the flexible laminate substrate has a thickness of 150 to 400 microns and comprises plastic films and aluminum foils laminated together.

5. The tube laminate as claimed in claim 1, wherein the protective transparent material coating has a thickness of 0.5 to 5 GSM.

6. A method of making a holographic flexible tube laminate for packaging, the method comprising the steps of:
(i) transferring a metalised holographic embossed pattern onto an adhesive layer applied on one outer surface of a flexible laminate substrate leaving out the edges of the laminate substrate;
(ii) optionally giving corona treatment to the holographic side of the laminate substrate;
(iii) printing the holographic side of the laminate substrate;
(vi) applying a protective transparent material coating comprising ultraviolet curing varnish on the printed side of the laminate substrate; and
(vii) forming the laminate substrate into a tube with the protective material coating side of the laminate substrate being the outer side of the tube and lap joining the edges of the laminate substrate by heat sealing.

7. The method as claimed in claim 6, wherein the transfer of the holographic embossed pattern is carried out by laminating a plastic film having the metalised holographic embossed pattern onto the flexible laminate substrate followed by delaminating the film.

8. The method as claimed in claim 6, wherein the adhesive layer has a thickness of 1.5 to 5 GSM and comprises reactive polyurethane based adhesive.

9. The method as claimed in claim 6, wherein the flexible laminate substrate has a thickness of 150 to 400 microns and comprises plastic films laminated together.

10. The method as claimed in claim 6, wherein the flexible laminate substrate has a thickness of 150 to 400 microns and comprises plastic films and aluminum foils laminated together.

11. The method as claimed in claim 6, wherein the protective transparent material coating has a thickness of 0.5 to 5 GSM.

12. The method as claimed in claim 6, wherein the edges of the laminate substrate are heat sealed by induction heating or welding.

13. The tube laminate as claimed in claim 2, wherein the flexible laminate substrate has a thickness of 150 to 400 microns and comprises plastic films laminated together.

14. The tube laminate as claimed in claim 2, wherein the flexible laminate substrate has a thickness of 150 to 400 microns and comprises plastic films and aluminum foils laminated together.

15. The method as claimed in claim 7, wherein the adhesive layer has a thickness of 1.5 to 5 GSM and comprises reactive polyurethane based adhesive.
